(19) United States
(12) Patent Application Publication
(10) Pub. No.: US 2026/0166435 A1
(43) Pub. Date: Jun. 18, 2026

(54) METHOD FOR GAME INTERACTION

(71) Applicant: NETEASE (HANGZHOU) NETWORK CO., LTD., Hangzhou, Zhejiang (CN)

(72) Inventor: Yudi TANG, Hangzhou, Zhejiang (CN)

(73) Assignee: NETEASE (HANGZHOU) NETWORK CO., LTD., Hangzhou, Zhejiang (CN)

(21) Appl. No.: 18/707,894

(22) PCT Filed: Apr. 18, 2022
(86) PCT No.: PCT/CN2022/087475

§ 371 Date: May 7, 2024

(30) Foreign Application Priority Data
Jan. 7, 2022 (CN) 202210017414.X

(51) Int. Cl. A63F 13/58

(52) U.S. Cl. CPC A63F 13/58

(57) ABSTRACT

A method for game interaction, including: displaying, in response to a trigger instruction for a game skill, a character capture area corresponding to the game skill in the graphical user interface; and obtaining, in response to an image collection instruction and in response to determining that the second player character is located in the character capture area, a position relationship between the first player character and the second player character in the game scene; and determining thermal information for the second player character according to the position relationship, and adding a corresponding thermal state to the second player character according to the thermal information.

### CROSS REFERENCE TO RELATED APPLICATIONS

The present application is a National Stage Application of International Application No. PCT/CN2022/087475 filed on Apr. 18, 2022 which is based upon and claims priority to Chinese Patent Application No. 202210017414.X entitled “Method and apparatus for game interaction, electronic device, and storage medium”, filed on Jan. 7, 2022, and the entire contents of both of which are incorporated herein by reference for all purposes.

### TECHNICAL FIELD

The present disclosure relates to the field of game technology, and in particular, to a method for game interaction, an apparatus for game interaction, an electronic device, and a computer-readable storage medium.

### BACKGROUND

With the development of computer technology and game technology, games have become an important entertainment manner in people's daily life. Among them, in related confrontation games, at least two game camps are divided, and the player characters of different game camps have different identities, such as defensive party and offensive party. In a round of game, the offensive party needs to obtain the corresponding game prop in the game scene or complete the specified game task to clear every level; and the defensive party needs to find the offensive party located in the game scene to prevent the offensive party from obtaining the corresponding game prop or completing the game task, etc.

### SUMMARY

According to embodiments of the present disclosure, there is disclosed a method for game interaction. The method includes:
displaying, in response to a trigger instruction for a game skill, a character capture area corresponding to the game skill in a graphical user interface, where the graphical user interface is provided through a preset terminal, a content displayed in the graphical user interface includes a part of a game scene and a first player character located in the game scene, and the game scene further includes a second player character in a different game camp from the first player character; and
obtaining, in response to an image collection instruction and in response to determining that the second player character is located in the character capture area, a position relationship between the first player character and the second player character in the game scene; and determining thermal information for the second player character according to the position relationship, and adding a corresponding thermal state to the second player character according to the thermal information.

### BRIEF DESCRIPTION OF THE DRAWINGS

FIG. 1 is a step flowchart of a method for game interaction according to some embodiments of the present disclosure;

FIG. 2 is a schematic diagram of a game interface according to some embodiments of the present disclosure;

FIG. 3 is a schematic diagram of a game interface according to some embodiments of the present disclosure;

FIG. 4 is a schematic diagram of a game interface according to some embodiments of the present disclosure;

FIG. 5 is a schematic diagram of a game interface according to some embodiments of the present disclosure;

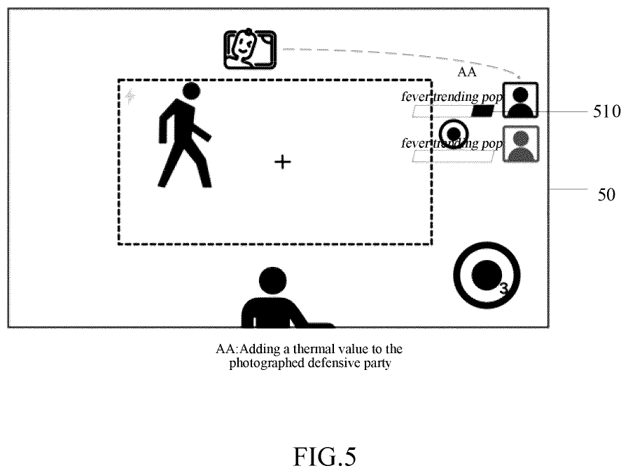

FIG. 6 is a schematic diagram of a game interface according to some embodiments of the present disclosure;

FIG. 7 is a structural block diagram of an apparatus for game interaction according to some embodiments of the present disclosure;

FIG. 8 is a block diagram of an electronic device according to some embodiments of the present disclosure;

FIG. 9 is a schematic diagram of a computer readable medium according to some embodiments of the present disclosure.

### DETAILED DESCRIPTION

In order to make the present disclosure more comprehensible, the present disclosure will be further described in detail below with reference to the accompanying drawings and specific embodiments.

The method for game interaction in the embodiments of the present disclosure may be run on a local terminal device or a server. When the method for game interaction is run on the server, the game may be a cloud game.

In some embodiments, the cloud game refers to a game manner based on cloud computing. In the running mode of the cloud game, the running body of the game program and the game screen presentation body are separated; the storage and running of the method for game interaction are completed on the cloud game server, and the role of the cloud game client is to receive and send data, and present the game screen. For example, the cloud game client can be a display device with a data transmission function close to the user side, such as a mobile terminal, a television, a computer, a palm computer, or the like. However, it is the cloud game server in the cloud to perform game data processing. When a game is performed, the player operates the cloud game client to send an operation instruction to the cloud game server, the cloud game server runs the game according to the operation instruction, encodes and compresses data such as the game screen, returns the data to the cloud game client through the network, and finally decodes and outputs the game screen through the cloud game client.

In some embodiments, the local terminal device stores a game program and is configured to present a game screen. The local terminal device is configured to interact with the player through a graphical user interface, that is, to conventionally download and install the game program through the electronic device and run it. The manner in which the local terminal device provides the graphical user interface to the player may include a variety of manners; for example, it may be rendered and displayed on a display screen of the terminal, or it may be provided to the player through holographic projection. For example, the local terminal device may include a display screen and a processor; the display screen is configured to present a graphical user interface; the graphical user interface includes a game screen; the processor is configured to run the game, generate the graphical user interface, and control the display of the graphical user interface on the display screen.

Among them, in the embodiments of the present disclosure, illustrative description is provided by taking that the local terminal device is a preset terminal as an example. It can be understood that local terminal device may also be the above-mentioned cloud game client, which is not limited in the present disclosure.

As an example, in a sneaking confrontation game, sneaking can be combined with asymmetric competition. Chasing and escaping confrontation can be performed in different game scenes. For example, a round of game may be composed of two defensive parties and four offensive parties. The offensive party has the advantage of the number of people, needs to hide from the view of the offensive party and the guard NPC (non-player character) in the game scene, sneaks to the target position, and completes the specified task and successfully evacuate. The defensive party has a strong strength, can see through the disguise of the offensive party under the assistance of the guard NPC, and chase the sneaking party in the game scene. In the game process, the defensive party needs to chase the offensive party, while the offensive party needs to hide from the chasing of the defensive party. However, for the game mode of “chasing and escaping”, a too single game interaction manner not only is prone to bring game fatigue feeling to the player, but also will bring poorer game experience to the player.

In this regard, according to embodiments of the present disclosure, there is provided a method and apparatus for game interaction, an electronic device, and a computer-readable storage medium, to solve or partially solve the problem in the related art that a too single game interaction manner brings game fatigue feeling and poorer game experience to the player. One of the core concepts in the embodiments of the present disclosure is to configure a corresponding game skill for a first player character in the game camp of an offensive party. The player may control the first player character to release the skill in the game, and perform “photographing” on the second player character, so that the corresponding thermal state is added to the second player character in the case of successful “photographing”. When the second player character in the thermal state moves in the game scene, the position of the second player character is displayed on a mini-map in the game, or the second player character is interfered by the non-player character in the game scene, or the second player character stays in place for a certain duration, etc. Therefore, by using image collection as a game skill of the player character, in the game process, the player can add the thermal state to the player character in an enemy camp through “in-game photographing”, thus greatly enriching the interactivity and interestingness of the game content, effectively reducing the game fatigue feeling of the player in the game process, and improving the game experience.

Among them, the player character involved in the embodiments of the present disclosure may be a character for the game controlled by a player in the game; the first player character may be a character controlled by a first player to which a first preset terminal belongs, which may be a defensive party in the game; the second player character may be a character controlled by a second player to which a second preset terminal belongs, which may be an offensive party in the game. It may be understood that, with the change of the game type, the first player character and the second player character may be mutually converted, which is not limited in the present disclosure.

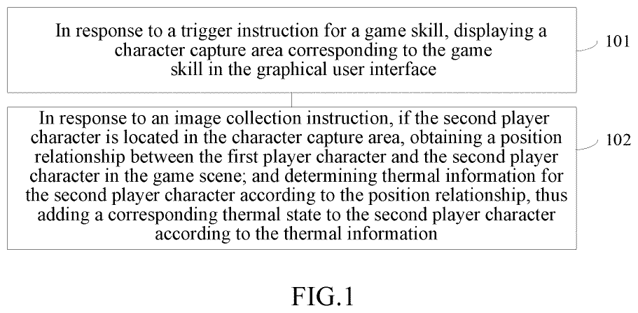

Referring to FIG. 1, it shows a step flowchart of a method for game interaction according to some embodiments of the present disclosure. A graphical user interface is provided through a preset terminal, and the contents displayed by the graphical user interface include at least a part of a game scene and a first player character located in the game scene, where, the game scene further includes a second player character in a different game camp from the first player character. The method may specifically include the following steps.

In step 101, in response to a trigger instruction for a game skill, a character capture area corresponding to the game skill is displayed in the graphical user interface.

In the embodiment of the present disclosure, for the first player character, the responsibility of the first player character may be to prevent the second player character from chasing the first player character, or to interfere with the movement of the second player character, etc. In this process, how to enable the second player character to be added with a corresponding abnormal state and limit the activity of the second player character is an important factor that affects the decryption progress or activity of the first player character in the game, and is also a key that the first player character is not captured by the second player character.

In the embodiment of the present disclosure, for the first player character, a corresponding game skill may be configured for the first player character. When the game skill is triggered, the terminal may display a character capture area in the graphical user interface. Among them, the display size of the character capture area may be smaller than the size of the graphical user interface, for example, taking a size of 50% of the length and width size of the graphical user interface as the display size, and may be fixedly displayed in the middle of the graphical user interface, etc. When the player triggers the game skill, after the terminal displays the character capture area in the graphical user interface, as the player switches the view orientation of the first player character, the content in the character capture area may also change accordingly. In some embodiments, the terminal may, in response to a view angle switching instruction for the first player character, control the current orientation of the first player character according to the view angle switching instruction, and display a game view presentation screen of the game scene in the current orientation in the graphical user interface, so that view-finding is performed on the game view presentation screen in the character capture area. Therefore, the player may adjust the content displayed in the character capture area by controlling the orientation of the first player character, so as to perform “photographing” on the second player character by adjusting the collection view angle, particularly, to perform image collection on the second player character in the moving state, etc.

In the game process, and in the above process that the player adjusts the view-finding content in the character capture area by adjusting the view orientation of the first player character, the terminal can detect the view-finding content in the character capture area in real time, especially detect the second player character. If the terminal detects that at least a part of the second player character is present in the character capture area, the terminal displays a collection indication identification for the character capture area in the graphical user interface, so as to prompt the player that the second player character has been captured in the current character capture area through the collection indication identification, and “photographing” can be performed on the second player character to enable the second player character to be added with a corresponding abnormal state. In some embodiments, when a part or all of the body of the second player character appears in the character capture area, it can be determined that the second player character is captured, and the terminal can display the corresponding collection indication identification. Among them, for a part of the body of the second player character, in order to improve the accuracy of image collection, it can be configured to determine that the second player character is captured when the head part of the second player character appears in the character capture area, and then display the corresponding collection indication identification.

In some embodiments, for the collection indication identification, it may be that the frame of the character capture area is displayed in green, accompanied by a flickering or non-flickering light effect, or the like, so as to prompt the player that the second player character has been captured in the current character capture area, and “photographing” may be performed on the second player character. It may be understood that, for the collection indication identification, it may also be displayed by other display styles; for example, it may be displayed in red, yellow, or the like; or it may be displayed by displaying a corresponding text prompt in the graphical user interface, which is not limited in the present disclosure.

In addition, as the player adjusts the view-finding content in the character capture area and controls the first player character, in a case that at least a part of the second player character is present in the character capture area, the terminal may also display thermal detection information corresponding to the position relationship in the character capture area. Among them, the thermal detection information may be image quality information of a collected image when image collection is performed based on a current position relationship between the first player character and the second player character in the game scene; if the image quality information is higher, it indicates that after the game skill is successfully released, the abnormal state level or abnormal value added to the second player character is higher, etc. For the position relationship, it may include a relative orientation between the first player character and the second player character; the relative orientation may include a front orientation, a back orientation, etc. For example, the front orientation may be a range of 180° on the front side of the second player character, and the back orientation may be a range of 180° on the back side of the second player character. The relative orientation may further include a relative distance between the first player character and the second player character in the game scene; the relative distance may include a straight-line distance between two player characters, or a shortest distance that the two player characters can move between each other, etc. Example description is provided by taking a straight-line distance as an example in the embodiments of the present disclosure.

In some embodiments, in the case that at least a part of the second player character is present in the character capture area, thermal detection information for the second player character is displayed in the character capture area according to the relative orientation and/or the relative distance. Among them, the thermal detection information may include a thermal identification. The more the number of the thermal identifications displayed in the character capture area is, the higher the image quality information is, and after the game skill is successfully released, the higher the abnormal state level or abnormal value added to the second player character is. Accordingly, in the game, if high image quality information is to be collected, it may be found by the second player corresponding to the second player character. Therefore, the player can reasonably control the number of times for game skill release, the distance for the release, the orientation for the release, or the like, according to its own requirements in the actual game, which is not limited in the present disclosure.

In some embodiments, in the case that at least a part of the second player character is present in the character capture area, if the first player character is located in the front orientation of the second player character, the terminal may determine a first number corresponding to the front orientation, and display a first number of thermal identifications for the second player character in the character capture area; and if the second player character is located in the back orientation of the second player character, the terminal may determine a second number corresponding to the back orientation, and display a second number of thermal identifications for the second player character in the character capture area.

For the front orientation and the back orientation, when the first player character releases the game skill in the front orientation of the second player character (to perform photographing), the front face of the second player character can be collected; and at this time, the quality of the collected image is higher, and the number of the corresponding thermal identifications is more. On the contrary, when the first player character releases the game skill in the back orientation of the second player character (to perform secret photographing), only the back face of the second player character can be collected; and at this time, since the front face of the second player character cannot be distinguished, the quality of the collected image is lower, and the number of the corresponding thermal identifications is less. In this regard, for the front orientation, a first number of thermal identifications may be set; for example, three thermal identifications are displayed in the character capture area. For the back orientation, a second number of thermal identifications may be set; for example, one thermal identification is displayed in the character capture area. Thus, when the player controls the first player character to perform “photographing” (releasing a skill) on the second player character from a corresponding angle, the terminal may display a corresponding number of thermal identifications in the character capture area according to that the first player character is located in which orientation of the second player character. Therefore, by displaying the corresponding number of thermal identifications, the player can intuitively and quickly perceive which abnormal state can be added to the second player character at the current angle for skill release, facilitating the player to make corresponding game decisions according to the actual game requirements, and improving the game experience of the player.

In some embodiments, in the case that at least a part of the second player character is present in the character capture area, the relative distance is compared with a preset distance range. A preset distance range within which the relative distance falls is taken as a target distance range. A target number corresponding to the target distance range is obtained, and a target number of thermal identifications for the second player character is displayed in the character capture area.

For the preset distance range, different distance ranges may be preset. Different distance ranges correspond to different numbers of thermal identifications. For example, the distance range of 0-5 meters corresponds to 3 thermal identifications, the distance range 5-10 meters corresponds to two thermal identifications, and the distance range of more than 10 meters corresponds to one thermal identification, etc. In the game process, the terminal may obtain a straight-line distance between the first player character and the second player character, determine a target distance range within which the straight-line distance falls by comparing the straight-line distance with preset different distance ranges, and then display a target number of thermal identifications corresponding to the target distance range in the character capture area. Thus, when the player controls the first player character to perform “photographing” (releasing a skill) from the corresponding angle, the terminal may display a corresponding number of thermal identifications in the character capture area according to the relative distance between the first player character and the second player character. Therefore, by displaying the corresponding number of thermal identifications, the player can intuitively and quickly perceive which abnormal state can be added to the second player character at the current angle for skill release, facilitating the player to make corresponding game decisions according to the actual game requirements, and improving the game experience of the player.

In addition, the terminal may further determine the number of thermal identifications according to the relative distance and the relative orientation, and then display the number of thermal identifications in the character capture area. In some embodiments, on the basis of determining the number of thermal identifications according to the preset distance range, a first number coefficient corresponding to the front orientation and a second number coefficient corresponding to the back orientation may be set, where the first number coefficient may be greater than 1, and the second number coefficient may be less than 1. Accordingly, after calculating and obtaining the number of thermal identifications on the basis of determining the number of thermal identifications according to the preset distance range, a final number of thermal identifications can be obtained by multiplying a corresponding coefficient according to that the first player character is located in which orientation of the second player character; and then, the thermal identifications can be displayed in the character capture area, so that the player can intuitively and quickly perceive which abnormal state can be added to the second player character at the current angle for skill release, facilitating the player to make corresponding game decisions according to the actual game requirements, and improving the game experience of the player.

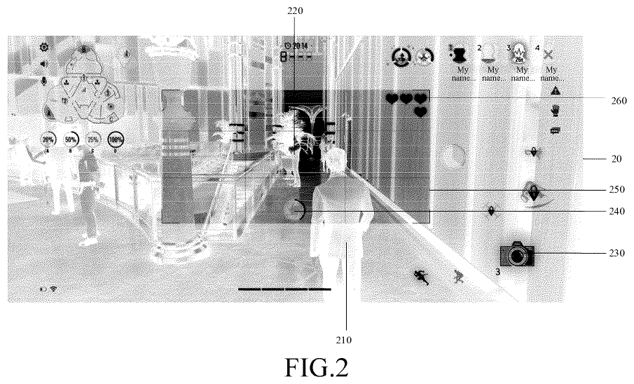

In an example, referring to FIG. 2, it shows a schematic diagram of a game interface according to some embodiments of the present disclosure. A game application is run through a terminal, and a game interface 20 is displayed in a graphical user interface. The game interface 20 may include a first player character 210, a second player character 220, a skill control 230, and an image collection control 240. In the game process, the player may firstly touch the skill control 230, and the terminal may display the character capture area 250 (the area corresponding to the nine squares in FIG. 2) corresponding to the game skill and the image collection control 240 corresponding to the character capture area in the graphical user interface in response to a touch operation for the skill control, and control the first player character to perform an image collection action. For the character capture area 250, the terminal may display a mask floating layer in the graphical user interface and retain a certain display area in the middle of the mask floating layer as the character capture area 250, so that the player adjusts the view-finding content displayed in the character capture area 250 by adjusting the current orientation of the first player character 210. In the view-finding process, with the change of the position relationship between the first player character 210 and the second player character 220, such as increase or decrease of the relative distance, change of the relative orientation, or the like, the terminal may display the corresponding thermal identification 260 in the character capture area 250 according to the position relationship, so that the player can intuitively and quickly perceive which abnormal state can be added to the second player character at the current angle for skill release, facilitating the player to make corresponding game decisions according to the actual game requirements, and improving the game experience of the player.

In addition, when the player touches the skill control 230 again, the terminal may hide the character capture area in the graphical user interface in response to a touch operation for the skill control, and display the game scene normally, so that the player can control the first player character 210 to perform other operations.

In step 102, in response to an image collection instruction, if the second player character is located in the character capture area, a position relationship between the first player character and the second player character in the game scene is obtained; and thermal information for the second player character is determined according to the position relationship, so as to add a corresponding thermal state to the second player character according to the thermal information.

In the embodiment of the present disclosure, after the player adjusts the view-finding content displayed in the character capture area by adjusting the current orientation of the first player character, the player may trigger image collection on the content in the character capture area by touching the image collection control. In some embodiments, the terminal may perform image collection on the content in the character capture area in response to a touch operation for the image collection control to obtain a target image. Then, the terminal may identify the target image. If the target image includes the second player character, the terminal may obtain a position relationship between the first player character and the second player character in the game scene, and determine thermal information for the second player character according to the position relationship, so as to add a corresponding thermal state to the second player character according to the thermal information. Therefore, by using image collection as a game skill of the player character, in the game process, the player can add the thermal state to the player character in an enemy camp through “in-game photographing”, thus greatly enriching the interactivity and interestingness of the game content, effectively reducing the game fatigue feeling of the player in the game process, and improving the game experience.

Among them, the thermal information may include a thermal value, and the thermal value may be an abnormal value superposed on the second player character. After the abnormal value reaches a certain value, a corresponding thermal state may be added to the second player character. The thermal state may be an abnormal state superposed on the player character, and different thermal states may trigger different interaction results for the player character.

In some embodiments, the terminal may calculate a target thermal value for the second player character by using the relative orientation and/or the relative distance. If the second player character is in the thermal state, the current thermal value of the second player character is obtained, and the target thermal value is superposed on the basis of the current thermal value. Therefore, the player may control the first player character to continuously release the game skill in the game, so as to superpose the thermal value of the second player character. After the thermal value reaches a certain value, adding a corresponding thermal state to the second player character is triggered. If the second player character is not in the thermal state, the target thermal value is taken as the current thermal value of the second player character. Therefore, the player can control the first player character to release the game skill, so as to superpose the thermal value of the second player character.

In some embodiments, the target thermal value for the second player character can be calculated through the relative distance and the relative orientation. In some embodiments, the terminal can obtain the thermal value for the relative distance, where different thermal values correspond to different preset distance ranges; then, the terminal can use the preset distance range successfully matched with the relative distance as the target distance range, and use the thermal value corresponding to the target distance range as the initial thermal value for the second player character; and then, the terminal can determine the thermal coefficient corresponding to the relative orientation, and calculate the target thermal value for the second player character by using the initial thermal value and the thermal coefficient.

Among them, for the thermal coefficient, if the first player character is located in the front orientation of the second player character, a first thermal coefficient for the initial thermal value is obtained; for example, the first thermal coefficient may be a coefficient greater than 1, including 1.1, 1.2, 1.3, etc. If the first player character is located in the back orientation of the second player character, a second thermal coefficient for the initial thermal value is obtained; for example, the second thermal coefficient may be a coefficient less than 1, including 0.9, 0.8, 0.7, etc., which is not limited in the present disclosure.

In an example, assuming that the preset distance range includes three different intervals of 0-5 meters, 5-10 meters, and more than 10 meters, and the corresponding thermal values may be 60, 40, and 20, respectively. When the relative distance between the first player character and the second player character is 4 meters, the terminal may determine that the initial thermal value is 40; and then, the terminal may judge that the first player character is located in which orientation of the second player character. If it is the front orientation, the terminal may obtain the corresponding thermal coefficient as 1.2, and may determine through calculating that a thermal value of 48 points may be superposed to the second player character through the current skill release.

In some embodiments, the target thermal value for the second player character may be determined through the relative orientation. In some embodiments, if the first player character is located in the front orientation of the second player character, the terminal may use the first thermal value corresponding to the front orientation as the target thermal value for the second player character. If the first player character is located in the back orientation of the second player character, the terminal may use the second thermal value corresponding to the back orientation as the target thermal value for the second player character.

For the front orientation and the back orientation, when the first player character releases the game skill (to perform photographing) in the front orientation of the second player character, the front face of the second player character can be collected; at this time, the quality of the collected image is higher, and the corresponding thermal value is higher. On the contrary, when the first player character is located in the back orientation of the second player character and releases the game skill (to perform secret photographing), only the back face of the second player character can be collected; at this time, since the front face of the second player character cannot be distinguished, the quality of the collected image is lower, and the corresponding thermal value is lower. In this regard, a first thermal value, such as 40, corresponding to the front orientation may be set; and a second thermal value, such as 25, corresponding to the back orientation may be set. Therefore, in the game, when the terminal determines that the first player character is located in the front orientation of the second player character when releasing the skill, the terminal may determine that a thermal value of 40 points may be superposed on the second player character through the current skill release. When the first player is located in the back orientation of the second player when releasing the skill, the terminal may determine that a thermal value of 25 points may be superposed on the second player character through the current skill release, etc.

In some embodiments, the target thermal value for the second player character may also be determined through the relative distance. In some embodiments, the terminal may use the preset thermal distance range successfully matched with the relative distance as the target distance range, and use the thermal value corresponding to the target distance range as the target thermal value for the second player character. For related processes, reference may be made to the foregoing description, and details are not described here again.

It should be noted that, since the game data interaction between the first terminal to which the first player belongs and the second terminal to which the second player belongs needs to be processed by the server, after the first terminal to which the first player belongs calculates the target thermal value for the second player character, the first terminal may send the target thermal value to the server, and the server performs corresponding data processing, including superposing the corresponding target thermal value on the second player character in the game, and performing real-time monitoring on the thermal value on the second player character, so as to determine according to the current thermal value of the second player character whether it is needed to superpose a corresponding thermal state, and to superpose a corresponding thermal state according to the magnitude of the thermal value when it is determined that it is needed. Among them, in the embodiments of the present disclosure, example description is provided by taking data interaction between the first terminal, the server, and the second terminal as an example. It can be understood that, in one case, for example, the first terminal or the second terminal is provided with a data processing capability, corresponding data processing may also be performed by the first terminal or the second terminal, including superposing a corresponding target thermal value on the second player character in the game, and performing real-time monitoring on the thermal value on the second player character, which is not limited in the present disclosure.

In some embodiments, after the first terminal to which the first player character belongs determines the target thermal value, the first terminal can send the target thermal value to the server. The server superposes the corresponding target thermal value on the second player character in the game, and performs real-time monitoring on the current thermal value of the second player character. If the current thermal value of the second player character is greater than or equal to a first thermal threshold and less than a second thermal threshold, the server adds a first-stage thermal state corresponding to the first thermal threshold to the second player character, where the first-stage thermal state is a state in which the second player character can be interacted by a non-player character and can be identified. If the current thermal value of the second player character is greater than or equal to the second thermal threshold and less than a third thermal threshold, the server adds a second-stage thermal state corresponding to the second thermal threshold to the second player character, where the second-stage thermal state is a state in which the second player character can be interfered by a non-player character. If the current thermal value of the second player character is greater than or equal to the third thermal threshold, the server adds a third-stage thermal state corresponding to the third thermal threshold to the second player character, where the third-stage thermal state is a state in which the second player character stays in place. Therefore, by using image collection as a game skill of the player character, in the game process, the player can add the thermal state to the player character in an enemy camp through “in-game photographing”, thus greatly enriching the interactivity and interestingness of the game content, effectively reducing the game fatigue feeling of the player in the game process, and improving the game experience.

In an example, assuming that the first thermal threshold is 100, the second thermal threshold is 200, and the third thermal threshold is 300, when the current thermal value of the second player character is greater than or equal to 100 and less than 200, a first-stage thermal state of “slightly famous” may be added to the second player character. In this state, when the second player controls the second player character to move in the game scene, the second terminal may obtain the relative distance between the second player character and a non-player character in the game scene. When the relative distance is less than or equal to a preset distance threshold, the second terminal may obtain a first interaction logic corresponding to the first-stage thermal state, and control the non-player character to interact with the second player character according to the first interaction logic. For example, when the front face of the second player character is close to the non-player character, the second terminal may control a first non-player character encountered by the second player character to say hello towards the second player character every 10 seconds, and at the same time highlight the position of the second player character, and display a position identification corresponding to the second player character in a mini-map of the game, so that the first player to which the first player character belongs may know the position of the second player character in the game scene through the game map.

When the current thermal value of the second player character is greater than or equal to 200 and less than 300, a second-stage thermal state of “popularity idol” may be added to the second player character. In this state, when the second player controls the second player character to move in the game scene, the second terminal may obtain the relative distance between the second player character and a non-player character in the game scene. When the relative distance is less than or equal to a preset distance threshold, the second terminal may obtain a second interaction logic corresponding to the second-stage thermal state, and control the non-player character to interact with the second player character according to the second interaction logic. For example, every 15 seconds, the second terminal may control a first non-player character within the orientation of the second player character to enter the “chasing state”, including changing the garment, entering the running state, or the like. And then, the second terminal may control the first non-player character to find a path and chase the second player character in a preset speed. After the second player character is chased by the non-player character, the second terminal may display a QTE (quick time event) for the first non-player character in the graphical user interface, such as a QTE of requesting for a signed photo in 3 seconds, etc. The second terminal may obtain the default action logic of the non-player character in response to the completion of the QTE event by the second player, control the non-player character to find a path and get back to the original point according to the default action logic, and execute an operation corresponding to the default action logic.

When the current thermal value of the second player character is greater than or equal to 300, a third-stage thermal state of “super-star in the hyper dimension” may be added to the second player character. In this state, the second terminal may control the second player character to stay in place for a certain duration; for example, the second terminal may display a board for the second player character in the game scene, and then control the second player character to dance in the board, thus limiting the movement of the second player character. At the same time, when the third-stage thermal state of the second player character is ended (for example, after the dance is ended), the second terminal may return the thermal state of the second player character to the second-stage thermal state, so as to effectively improve the interestingness of the game by reasonably displaying the action of the second player character.

In addition, after the first player successfully controls the first player character to “perform photographing” on the second player character (i.e., to release the skill successfully), the first terminal may further display the thermal information for the second player character in the graphical user interface, including displaying the character avatar of the second player character and the corresponding thermal strip in the graphical user interface. Among them, the thermal strip corresponds to the thermal value; for example, the thermal strip may be a circular ring surrounding the character avatar, and may be set as three segments, respectively corresponding to the first-stage thermal state, the second-stage thermal state, the third-stage thermal state, etc. Therefore, the player can intuitively and quickly know the current thermal state of the second player character, so as to reasonably control the release of the game skill, thus ensuring the game experience of the player in the game.

In the game, there is a cooling time for the game skill of the first player character. In the game process, the second player may control the second player character to hide from the game skill of the first player character. In the game process, if the current thermal value of the second player character is not increased within a preset duration, the terminal may perform decrement on the thermal value of the second player character at every preset time interval, for example, reducing a thermal value of 3 points every 1 second, etc. Therefore, the game experiences of different players in the game are effectively improved by reasonably setting the game interaction manner.

In the embodiment of the present disclosure, a graphical user interface is provided through a preset terminal. The graphical user interface may include a game scene, a first player character located in the game scene, and a second player character in a different game camp from the first player character. In the game process, the terminal may display, in response to a trigger instruction for a game skill, a character capture area corresponding to the game skill in the graphical user interface; then, the terminal may obtain, in response to an image collection instruction and if the second player character is located in the character capture area, a position relationship between the first player character and the second player character in the game scene, and determine thermal information for the second player character according to the position relationship, so as to add a corresponding thermal state to the second player character according to the thermal information and display the thermal information for the second player character in the graphical user interface. Therefore, by using image collection as a game skill of the player character, in the game process, the player can add the thermal state to the player character in an enemy camp through “in-game photographing”, thus greatly enriching the interactivity and interestingness of the game content, effectively reducing the game fatigue feeling of the player in the game process, and improving the game experience.

In order to enable those skilled in the art to better understand the technical solutions of the embodiments of the present disclosure, an example description is made below through an example.

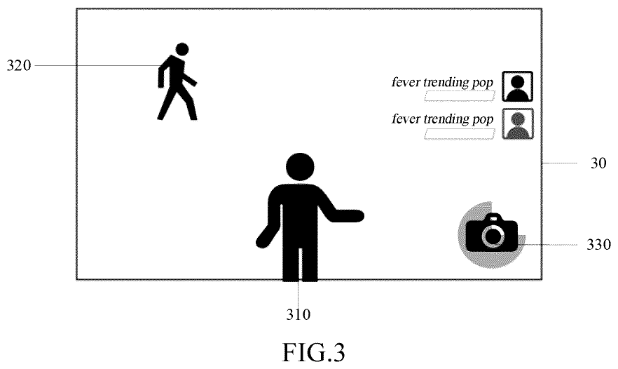

Referring to FIG. 3, it shows a schematic diagram of a game interface according to some embodiments of the present disclosure. A terminal runs a game application, and displays a game interface 30 in a graphical user interface. The game interface 30 may include a first player character 310, a second player character 320, and a skill control 330 corresponding to a game skill of the first player character 310. In the game process, the player may control the first player character 310 to release the corresponding game skill, such as a photographing restriction skill, by touching the skill control 330.

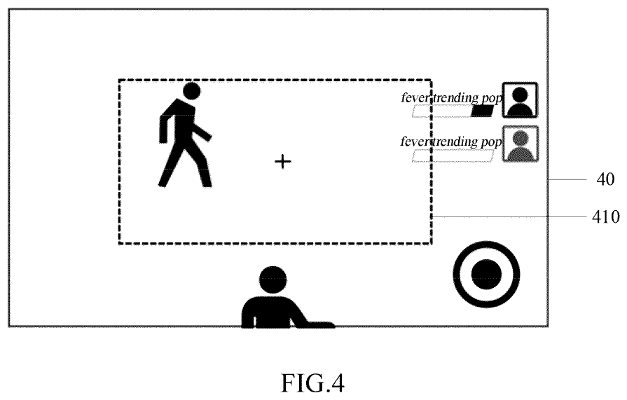

Referring to FIG. 4, in the game process, when a player touches the skill control 330, the terminal may display the character capture area 410 in the graphical user interface in response to a touch operation for the skill control, so that the player may enable the terminal to display a game view presentation screen corresponding to the current orientation of the first player character in the game interface 40 by controlling the first player character to perform view switch. The character capture area 410 may be another layer fixedly displayed in the graphical user interface. When the game view presentation screen changes, the view-finding content in the character capture area 410 changes accordingly, so that when the second player character is located in the character capture area 410 through adjusting the view-finding content of the character capture area 410 by the player, then, the plyer may further perform photographing on the second player character to release the corresponding game skill for the second player character. Among them, when the player adjusts the view-finding content in the character capture area, the terminal may perform identification on the content of the character capture area in real time. When it is identified that at least a part of the second player character is present in the character capture area, the terminal may obtain the position relationship between the first player character and the second player character present in the character capture area, and display a corresponding number of thermal identifications in the character capture area according to the position relationship. Meanwhile, when the player releases the game skill through the image collection control corresponding to the game skill, that is, when the player performs photographing on the second player character located in the character capture area, the terminal may calculate a corresponding thermal value according to the position relationship between the first player character and the photographed second player character in the game scene, and superpose the corresponding thermal value on the second player character. At the same time, the terminal displays information corresponding to the thermal value on the second player character in the thermal strip 510 in the game interface 50. For example, the thermal strip may include three different stages of thermal states, such as fever, trending, and pop, where pop may correspond to the first-stage thermal state, trending may correspond to the second-stage thermal state, and fever may correspond to the third-stage thermal state, etc. When the thermal value on the second player character reaches a trigger threshold for the thermal state, it may be triggered that a corresponding thermal state is superposed on the second player character. Different thermal states are mutually exclusive; that is, only one thermal state may be added to the second player character at the same time. Therefore, by using image collection as a game skill of the player character, in the game process, the player can add the thermal state to the player character in an enemy camp through “in-game photographing”, thus greatly enriching the interactivity and interestingness of the game content, effectively reducing the game fatigue feeling of the player in the game process, and improving the game experience.

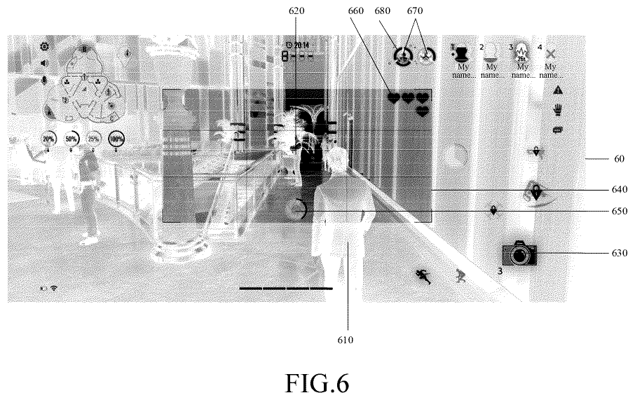

In some embodiments, referring to FIG. 6, it shows a schematic diagram of a game interface according to some embodiments of the present disclosure. A game application is run through a terminal, a game interface 60 is displayed in a graphical user interface, and the game interface 60 may include a first player character 610, a second player character 620, a skill control 630, or the like. When the skill control 630 is touched by the player, the terminal may display the character capture area 640 (the area corresponding to the 9-box grid in FIG. 6) and the corresponding image collection control 650 in the game interface 60. Then the player may control the first player character to perform view switching to adjust the view-finding content in the character capture area 640. After the adjustment is completed, the player may control the first player character 610 to perform the image collection action through touching the image collection control 650. Among them, in the process of adjusting the character capture area 640 to perform view-finding by the player, as the position relationship between the first player character 610 and the second player character 620 changes, such as, decrease or increase of the relative distance, change of the relative orientation, or the like, the terminal may display the corresponding thermal identification 660 in the character capture area 650 according to the position relationship, so that the player may intuitively and quickly perceive which abnormal state can be added to the second player character at the current angle for skill release. After the view-finding content is determined, the player may touch the image collection control 650 to perform image collection on the content in the current character capture area 640. The terminal may respond to the touch operation of the player for the image collection control 650, and play the corresponding photographing effect (such as one time of screen flashing, etc.) in the graphical user interface, then calculate the corresponding thermal value according to the position relationship between the first player character 610 and the second player character 620 in the game scene, and then display the photographed character avatar 670 of the second player character and the corresponding thermal strip 680 in the game interface 60. Therefore, the player can intuitively and quickly know the current thermal state of the second player character, so as to reasonably control the release of the game skill, thus ensuring the game experience of the player in the game.

For the second player character superposed with the thermal value, the second terminal or the server may add a corresponding thermal state to the second player character according to the numerical value of the thermal value, so as to limit the movement of the second player character in the game scene. At the same time, with the change of the game process, such as, the second player controlling the second player character to hide from the photographing skill of the first player character or go into hiding to drop the thermal value, etc., the thermal value or thermal state of the second player character may be eliminated. The related content may refer to the description of the foregoing embodiments, and details are not described here again.

It should be noted that, for the method embodiments, for simplicity of description, they are expressed as a series of action combinations. However, those skilled in the art should understand that the embodiments of the present disclosure are not limited by the described action sequence, because some steps may be performed in other sequences or simultaneously according to the embodiments of the present disclosure. Secondly, those skilled in the art should also know that the embodiments described in the description are all preferred embodiments, and the involved actions are not necessarily required by the embodiments of the present disclosure.

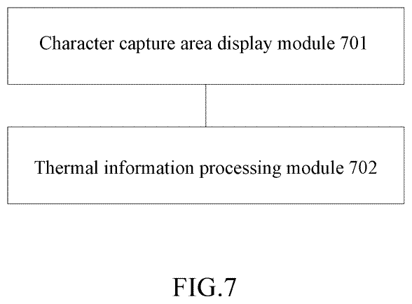

Referring to FIG. 7, it shows a structural block diagram of an apparatus for game interaction according to some embodiments of the present disclosure. The content displayed in the graphical user interface includes at least a part of a game scene and a first player character located in the game scene, where the game scene further includes a second player character in a different game camp from the first player character. The apparatus may specifically include the following modules: a character capture area display module 701 and a thermal information processing module 702.

The character capture area display module 701 is configured to display a character capture area corresponding to a game skill in the graphical user interface in response to a trigger instruction for the game skill.

The thermal information processing module 702 is configured to, in response to an image collection instruction, if the second player character is located in the character capture area, obtain a position relationship between the first player character and the second player character in the game scene, and determine thermal information for the second player character according to the position relationship, so as to add a corresponding thermal state to the second player character according to the thermal information.

For the apparatus embodiments, since they are basically similar to the method embodiments, the description is relatively simple, and the relevant parts may refer to the part of the description of the method embodiments.

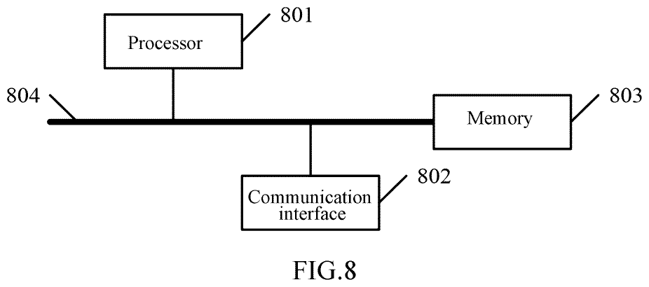

In addition, according to an embodiment of the present disclosure, there is further provided an electronic device, as shown in FIG. 8, including a processor 801, a communication interface 802, a memory 803, and a communication bus 804, where the processor 801, the communication interface 802, and the memory 803 complete mutual communication through the communication bus 804.

The memory 803 is configured to store a computer program.

The processor 801 is configured to, when executing the program stored in the memory 803, implement the following steps:
displaying, in response to a trigger instruction for a game skill, a character capture area corresponding to the game skill in the graphical user interface; and
obtaining, in response to an image collection instruction and if the second player character is located in the character capture area, a position relationship between the first player character and the second player character in the game scene; and determining thermal information for the second player character according to the position relationship, so as to add a corresponding thermal state to the second player character according to the thermal information.

In some embodiments, after displaying, in response to the trigger instruction for the game skill, the character capture area corresponding to the game skill in the graphical user interface, the method further includes:
controlling, in response to a view angle switching instruction for the first player character, a current orientation of the first player character according to the view angle switching instruction; and displaying, in the graphical user interface, a game view presentation screen of the game scene in the current orientation, so as to perform view-finding on the game view presentation screen in the character capture area.

In some embodiments, the method further includes:
displaying, if it is detected that at least a part of the second player character is present in the character capture area, a collection indication identification for the character capture area in the graphical user interface.

In some embodiments, displaying, if it is detected that at least a part of the second player character is present in the character capture area, the collection indication identification for the character capture area in the graphical user interface, includes:
displaying, if it is detected that at least a head part of the second player character is present in the character capture area, the collection indication identification for the character capture area in the graphical user interface.

In some embodiments, the method further includes:
displaying, in a case that at least a part of the second player character is present in the character capture area, thermal detection information corresponding to the position relationship in the character capture area.

In some embodiments, the position relationship includes a relative orientation and a relative distance; and, displaying, in the case that at least a part of the second player character is present in the character capture area, the thermal detection information corresponding to the position relationship in the character capture area, includes:
displaying, in the case that at least a part of the second player character is present in the character capture area, thermal detection information for the second player character in the character capture area according to the relative orientation and/or the relative distance.

In some embodiments, the thermal detection information includes a thermal identification; and, displaying, in the case that at least a part of the second player character is present in the character capture area, the thermal detection information for the second player character in the character capture area according to the relative orientation and/or the relative distance, includes:
determining, in the case that at least a part of the second player character is present in the character capture area and if the first player character is located in a front orientation of the second player character, a first number corresponding to the front orientation; and displaying the first number of thermal identifications for the second player character in the character capture area; and
determining, if the second player character is located in a back orientation of the second player character, a second number corresponding to the back orientation; and displaying the second number of thermal identifications for the second player character in the character capture area.

In some embodiments, the thermal detection information includes a thermal identification; and, displaying, in the case that at least a part of the second player character is present in the character capture area, the thermal detection information for the second player character in the character capture area according to the relative orientation and/or the relative distance, includes:
comparing, in the case that at least a part of the second player character is present in the character capture area, the relative distance with a preset distance range; taking a preset distance range within which the relative distance falls as a target distance range; and obtaining a target number corresponding to the target distance range; and
displaying the target number of thermal identifications for the second player character in the character capture area.

In some embodiments, the position relationship includes a relative orientation and a relative distance; and, determining the thermal information for the second player character according to the position relationship, includes:
determining the thermal information for the second player character according to the relative orientation and/or the relative distance.

In some embodiments, the thermal information includes a thermal value; and, determining the thermal information for the second player character according to the relative orientation and/or the relative distance, includes:
calculating a target thermal value for the second player character by using the relative orientation and/or the relative distance;
obtaining, if the second player character is in a thermal state, a current thermal value for the second player character, and superposing the target thermal value based on the current thermal value; and
taking, if the second player character is not in the thermal state, the target thermal value as the current thermal value for the second player character.

In some embodiments, calculating the target thermal value for the second player character by using the relative orientation and/or the relative distance, includes:
obtaining a thermal value for the relative distance, where different thermal values corresponds to different preset distance ranges;
taking a preset distance range successfully matched with the relative distance as a target distance range, and taking a thermal value corresponding to the target distance range as an initial thermal value for the second player character;
determining a thermal coefficient corresponding to the relative orientation; and
calculating the target thermal value for the second player character by using the initial thermal value and the thermal coefficient.

In some embodiments, determining the thermal coefficient corresponding to the relative orientation includes:
obtaining, if the first player character is located in a front orientation of the second player character, a first thermal coefficient for the initial thermal value; and
obtaining, if the second player character is located in a back orientation of the second player character, a second thermal coefficient for the initial thermal value.

In some embodiments, calculating the target thermal value for the second player character by using the relative orientation, includes:
taking, if the first player character is located in a front orientation of the second player character, a first thermal value corresponding to the front orientation as the target thermal value for the second player character; and
taking, if the second player character is located in a back orientation of the second player character, a second thermal value corresponding to the back orientation as the target thermal value for the second player character.

In some embodiments, calculating the target thermal value for the second player character by using the relative distance, includes:
taking a preset thermal distance range successfully matched with the relative distance as a target distance range; and taking a thermal value corresponding to the target distance range as the target thermal value for the second player character.

In some embodiments, the thermal information includes a thermal value; and adding the corresponding thermal state to the second player character according to the thermal information includes:
adding, if a current thermal value for the second player character is greater than or equal to a first thermal threshold and less than a second thermal threshold, a first-stage thermal state corresponding to the first thermal threshold to the second player character, where the first-stage thermal state is a state in which the second player character is to be identifiable and to be interacted by a non-player character;
adding, if the current thermal value for the second player character is greater than or equal to the second thermal threshold and less than a third thermal threshold, a second-stage thermal state corresponding to the second thermal threshold to the second player character, where the second-stage thermal state is a state in which the second player character is to be interfered by a non-player character; and
adding, if the current thermal value for the second player character is greater than or equal to the third thermal threshold, a third-stage thermal state corresponding to the third thermal threshold to the second player character, where the third-stage thermal state is a state in which the second player character stays in place.

In some embodiments, the method further includes:
adding, if it is detected that the third-stage thermal state of the second player character is ended, the second-stage thermal state to the second player character.

In some embodiments, the method further includes:
displaying a character avatar of the second player character and a thermal strip in the graphical user interface.

In some embodiments, the thermal information includes a thermal value, and the method further includes:
performing, if a current thermal value for the second player character is not increased within a preset duration, decrement on a thermal value for the second player character at every preset time interval.

In some embodiments, the content displayed in the graphical user interface further includes a skill control corresponding to the game skill of the first player character; and displaying, in response to the trigger instruction for the game skill, the character capture area corresponding to the game skill in the graphical user interface, includes:
displaying, in response to a touch operation for the skill control, the character capture area corresponding to the game skill and an image collection control corresponding to the character capture area in the graphical user interface; and controlling the first player character to perform an image collection action.

In some embodiments, obtaining, in response to the image collection instruction and if the second player character is located in the character capture area, the position relationship between the first player character and the second player character in the game scene, includes:
performing, in response to a touch operation for the image collection control, image collection on a content in the character capture area to obtain a target image; and
obtaining, if the target image includes the second player character, the position relationship between the first player character and the second player character in the game scene.

In some embodiments, the method further includes:
hiding, in response to a touch operation for the skill control, the character capture area in the graphical user interface.

The communication bus mentioned above may be a peripheral component interconnect (PCI) bus or an extended industry standard architecture (EISA) bus, etc. The communication bus may be classified into an address bus, a data bus, a control bus, or the like. For ease of representation, only one thick line is used to represent the communication bus in the drawing, but it does not mean that there is only one bus or one type of bus.

The communication interface is used for communication between the terminal and other devices.

The memory may include a random access memory (RAM), or may include a non-volatile memory, such as, at least one magnetic disk memory. In some embodiments, the memory may further be at least one storage device located away from the processor.

The above-mentioned processor may be a general-purpose processor, including a central processing unit (CPU), a network processor (NP), etc., or may be a digital signal processor (DSP), an application specific integrated circuit (ASIC), a field-programmable gate array (FPGA), or another programmable logic device, discrete gate or transistor logic device, or discrete hardware component.

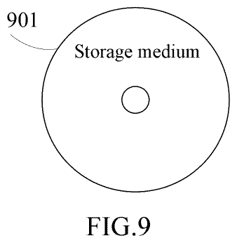

As shown in FIG. 9, according to yet another embodiment provided in the present disclosure, there is further provided a computer-readable storage medium 901. An instruction is stored in the computer-readable storage medium, and when the instruction runs on a computer, the computer is enabled to execute the following method steps:
displaying, in response to a trigger instruction for a game skill, a character capture area corresponding to the game skill in the graphical user interface; and
obtaining, in response to an image collection instruction and if the second player character is located in the character capture area, a position relationship between the first player character and the second player character in the game scene; and determining thermal information for the second player character according to the position relationship, so as to add a corresponding thermal state to the second player character according to the thermal information.

In some embodiments, after displaying, in response to the trigger instruction for the game skill, the character capture area corresponding to the game skill in the graphical user interface, the method further includes:
controlling, in response to a view angle switching instruction for the first player character, a current orientation of the first player character according to the view angle switching instruction; and displaying, in the graphical user interface, a game view presentation screen of the game scene in the current orientation, so as to perform view-finding on the game view presentation screen in the character capture area.

In some embodiments, the method further includes:
displaying, if it is detected that at least a part of the second player character is present in the character capture area, a collection indication identification for the character capture area in the graphical user interface.

In some embodiments, displaying, if it is detected that at least a part of the second player character is present in the character capture area, the collection indication identification for the character capture area in the graphical user interface, includes:
displaying, if it is detected that at least a head part of the second player character is present in the character capture area, the collection indication identification for the character capture area in the graphical user interface.

In some embodiments, the method further includes:
displaying, in a case that at least a part of the second player character is present in the character capture area, thermal detection information corresponding to the position relationship in the character capture area.

In some embodiments, the position relationship includes a relative orientation and a relative distance; and, displaying, in the case that at least a part of the second player character is present in the character capture area, the thermal detection information corresponding to the position relationship in the character capture area, includes:
displaying, in the case that at least a part of the second player character is present in the character capture area, thermal detection information for the second player character in the character capture area according to the relative orientation and/or the relative distance.

In some embodiments, the thermal detection information includes a thermal identification; and, displaying, in the case that at least a part of the second player character is present in the character capture area, the thermal detection information for the second player character in the character capture area according to the relative orientation and/or the relative distance, includes:
determining, in the case that at least a part of the second player character is present in the character capture area and if the first player character is located in a front orientation of the second player character, a first number corresponding to the front orientation; and displaying the first number of thermal identifications for the second player character in the character capture area; and
determining, if the second player character is located in a back orientation of the second player character, a second number corresponding to the back orientation; and displaying the second number of thermal identifications for the second player character in the character capture area.

In some embodiments, the thermal detection information includes a thermal identification; and, displaying, in the case that at least a part of the second player character is present in the character capture area, the thermal detection information for the second player character in the character capture area according to the relative orientation and/or the relative distance, includes:
comparing, in the case that at least a part of the second player character is present in the character capture area, the relative distance with a preset distance range; taking a preset distance range within which the relative distance falls as a target distance range; and obtaining a target number corresponding to the target distance range; and
displaying the target number of thermal identifications for the second player character in the character capture area.

In some embodiments, the position relationship includes a relative orientation and a relative distance; and, determining the thermal information for the second player character according to the position relationship, includes:
determining the thermal information for the second player character according to the relative orientation and/or the relative distance.

In some embodiments, the thermal information includes a thermal value; and, determining the thermal information for the second player character according to the relative orientation and/or the relative distance, includes:
calculating a target thermal value for the second player character by using the relative orientation and/or the relative distance;
obtaining, if the second player character is in a thermal state, a current thermal value for the second player character, and superposing the target thermal value based on the current thermal value; and
taking, if the second player character is not in the thermal state, the target thermal value as the current thermal value for the second player character.

In some embodiments, calculating the target thermal value for the second player character by using the relative orientation and/or the relative distance, includes:
obtaining a thermal value for the relative distance, where different thermal values corresponds to different preset distance ranges;
taking a preset distance range successfully matched with the relative distance as a target distance range, and taking a thermal value corresponding to the target distance range as an initial thermal value for the second player character;
determining a thermal coefficient corresponding to the relative orientation; and
calculating the target thermal value for the second player character by using the initial thermal value and the thermal coefficient.

In some embodiments, determining the thermal coefficient corresponding to the relative orientation includes:
obtaining, if the first player character is located in a front orientation of the second player character, a first thermal coefficient for the initial thermal value; and
obtaining, if the second player character is located in a back orientation of the second player character, a second thermal coefficient for the initial thermal value.

In some embodiments, calculating the target thermal value for the second player character by using the relative orientation, includes:
taking, if the first player character is located in a front orientation of the second player character, a first thermal value corresponding to the front orientation as the target thermal value for the second player character; and
taking, if the second player character is located in a back orientation of the second player character, a second thermal value corresponding to the back orientation as the target thermal value for the second player character.

In some embodiments, calculating the target thermal value for the second player character by using the relative distance, includes:
taking a preset thermal distance range successfully matched with the relative distance as a target distance range; and taking a thermal value corresponding to the target distance range as the target thermal value for the second player character.

In some embodiments, the thermal information includes a thermal value; and adding the corresponding thermal state to the second player character according to the thermal information includes:
adding, if a current thermal value for the second player character is greater than or equal to a first thermal threshold and less than a second thermal threshold, a first-stage thermal state corresponding to the first thermal threshold to the second player character, where the first-stage thermal state is a state in which the second player character is to be identifiable and to be interacted by a non-player character;
adding, if the current thermal value for the second player character is greater than or equal to the second thermal threshold and less than a third thermal threshold, a second-stage thermal state corresponding to the second thermal threshold to the second player character, where the second-stage thermal state is a state in which the second player character is to be interfered by a non-player character; and
adding, if the current thermal value for the second player character is greater than or equal to the third thermal threshold, a third-stage thermal state corresponding to the third thermal threshold to the second player character, where the third-stage thermal state is a state in which the second player character stays in place.

In some embodiments, the method further includes:
adding, if it is detected that the third-stage thermal state of the second player character is ended, the second-stage thermal state to the second player character.

In some embodiments, the method further includes:
displaying a character avatar of the second player character and a thermal strip in the graphical user interface.

In some embodiments, the thermal information includes a thermal value, and the method further includes:
performing, if a current thermal value for the second player character is not increased within a preset duration, decrement on a thermal value for the second player character at every preset time interval.

In some embodiments, the content displayed in the graphical user interface further includes a skill control corresponding to the game skill of the first player character; and displaying, in response to the trigger instruction for the game skill, the character capture area corresponding to the game skill in the graphical user interface, includes:
displaying, in response to a touch operation for the skill control, the character capture area corresponding to the game skill and an image collection control corresponding to the character capture area in the graphical user interface; and controlling the first player character to perform an image collection action.

In some embodiments, obtaining, in response to the image collection instruction and if the second player character is located in the character capture area, the position relationship between the first player character and the second player character in the game scene, includes:
performing, in response to a touch operation for the image collection control, image collection on a content in the character capture area to obtain a target image; and
obtaining, if the target image includes the second player character, the position relationship between the first player character and the second player character in the game scene.

In some embodiments, the method further includes:
hiding, in response to a touch operation for the skill control, the character capture area in the graphical user interface.

According to yet another embodiment of the present disclosure, there is further provided a computer program product including an instruction. When the instruction runs on a computer, the computer is enabled to perform the method for game interaction described in the above embodiments.

The above embodiments may be all or partially implemented by software, hardware, firmware, or any combination of them. When implemented using software, they may be all or partially implemented in the form of a computer program product. The computer program product includes one or more computer instructions. When the computer program instruction is loaded and executed on a computer, the processes or functions according to the embodiments of the present disclosure are all or partially generated. The computer may be a general purpose computer, a special purpose computer, a computer network, or another programmable apparatus. The computer instruction may be stored in a computer-readable storage medium or transmitted from one computer-readable storage medium to another computer-readable storage medium. For example, the computer instruction may be transmitted from a website site, computer, server, or data center to another website site, computer, server, or data center in a wired manner (e.g., coaxial cable, optical fiber, digital subscriber line (DSL)) or a wireless manner (e.g., infrared, wireless, microwave, etc.). The computer-readable storage medium may be any available medium accessible by a computer, or a data storage device such as a server or a data center integrated with one or more available medium. The available medium may be a magnetic medium (e.g., a floppy disk, a hard disk, or a magnetic tape), an optical medium (e.g., a DVD), or a semiconductor medium (e.g., a solid state disk (SSD)), etc.

It should be noted that, in the context, relational terms, such as “first” and “second”, are merely used to distinguish one entity or operation from another entity or operation, and do not necessarily require or imply that there is such actual relationship or sequence among these entities or operations. Moreover, the term “comprising”, “including”, or any other variant of them is intended to cover a non-exclusive inclusion, such that a process, method, article, or device that includes a series of elements includes not only those elements, but also other elements not explicitly listed, or elements inherent to such a process, method, article, or device. In the absence of more restrictions, the element defined by the statement “including a . . . ” does not exclude the presence of additional identical elements in the process, method, article, or device that includes the element.

Various embodiments in the present specification are described in a related manner, the same or similar parts between the various embodiments can refer to each other, and each embodiment focuses on the difference from other embodiments. In particular, for the system embodiment, since it is basically similar to the method embodiment, the description is relatively simple, and the related part may refer to the part of description of the method embodiment.

The foregoing is merely preferred embodiments of the present disclosure and is not intended to limit the protection scope of the present disclosure. Any modification, equivalent replacement, improvement, etc., made within the spirit and principle of the present disclosure is included within the protection scope of the present disclosure.

1. A method for game interaction, comprising:
displaying, in response to a trigger instruction for a game skill, a character capture area corresponding to the game skill in a graphical user interface, wherein the graphical user interface is provided through a preset terminal, a content displayed in the graphical user interface comprises a part of a game scene and a first player character located in the game scene, and the game scene further comprises a second player character in a different game camp from the first player character; and
obtaining, in response to an image collection instruction and in response to determining that the second player character is located in the character capture area, a position relationship between the first player character and the second player character in the game scene; and determining thermal information for the second player character according to the position relationship, and adding a corresponding thermal state to the second player character according to the thermal information.

2. The method according to claim 1, wherein the method further comprises:
controlling, in response to a view angle switching instruction for the first player character, a current orientation of the first player character according to the view angle switching instruction; and displaying, in the graphical user interface, a game view presentation screen of the game scene in the current orientation, so as to perform view-finding on the game view presentation screen in the character capture area.

3. The method according to claim 2, further comprising:
displaying, in response to detecting that a part of the second player character is present in the character capture area, a collection indication identification for the character capture area in the graphical user interface.

4. The method according to claim 3, wherein displaying, in response to detecting that a part of the second player character is present in the character capture area, the collection indication identification for the character capture area in the graphical user interface, comprises:
displaying, in response to detecting that a head part of the second player character is present in the character capture area, the collection indication identification for the character capture area in the graphical user interface.

5. The method according to claim 3, further comprising:
displaying, in response to determining that a part of the second player character is present in the character capture area, thermal detection information corresponding to the position relationship in the character capture area.

6. The method according to claim 5, wherein the position relationship comprises a relative orientation and a relative distance; and, displaying, in response to determining that a part of the second player character is present in the character capture area, the thermal detection information corresponding to the position relationship in the character capture area, comprises:
displaying, in response to determining that a part of the second player character is present in the character capture area, thermal detection information for the second player character in the character capture area according to the relative orientation or the relative distance.

7. The method according to claim 6, wherein the thermal detection information comprises a thermal identification; and, displaying, in response to determining that a part of the second player character is present in the character capture area, the thermal detection information for the second player character in the character capture area according to the relative orientation or the relative distance, comprises:
determining, in response to determining that a part of the second player character is present in the character capture area and the first player character is located in a front orientation of the second player character, a first number corresponding to the front orientation; and displaying the first number of thermal identifications for the second player character in the character capture area; and
determining, in response to determining that the second player character is located in a back orientation of the second player character, a second number corresponding to the back orientation; and displaying the second number of thermal identifications for the second player character in the character capture area.

8. The method according to claim 6, wherein the thermal detection information comprises a thermal identification; and, displaying, in response to determining that a part of the second player character is present in the character capture area, the thermal detection information for the second player character in the character capture area according to the relative orientation and/or the relative distance, comprises:
comparing, in response to determining that a part of the second player character is present in the character capture area, the relative distance with a preset distance range; taking a preset distance range within which the relative distance falls as a target distance range; and obtaining a target number corresponding to the target distance range; and
displaying the target number of thermal identifications for the second player character in the character capture area.

9. The method according to claim 1, wherein the position relationship comprises a relative orientation and a relative distance; and, determining the thermal information for the second player character according to the position relationship, comprises:
determining the thermal information for the second player character according to the relative orientation and/or the relative distance.

10. The method according to claim 9, wherein the thermal information comprises a thermal value; and, determining the thermal information for the second player character according to the relative orientation and/or the relative distance, comprises:
calculating a target thermal value for the second player character by using the relative orientation and/or the relative distance;
obtaining, in response to determining that the second player character is in a thermal state, a current thermal value for the second player character, and superposing the target thermal value based on the current thermal value; and
taking, in response to determining that the second player character is not in the thermal state, the target thermal value as the current thermal value for the second player character.

11. The method according to claim 10, wherein calculating the target thermal value for the second player character by using the relative orientation and/or the relative distance, comprises:
obtaining a thermal value for the relative distance, wherein different thermal values corresponds to different preset distance ranges;
taking a preset distance range successfully matched with the relative distance as a target distance range, and taking a thermal value corresponding to the target distance range as an initial thermal value for the second player character;
determining a thermal coefficient corresponding to the relative orientation; and
calculating the target thermal value for the second player character by using the initial thermal value and the thermal coefficient.

12. The method according to claim 11, wherein determining the thermal coefficient corresponding to the relative orientation comprises at least one of:
obtaining, in response to determining that the first player character is located in a front orientation of the second player character, a first thermal coefficient for the initial thermal value; or
obtaining, in response to determining that the second player character is located in a back orientation of the second player character, a second thermal coefficient for the initial thermal value.

13. The method according to claim 10, wherein calculating the target thermal value for the second player character by using the relative orientation, comprises at least one of:
taking, in response to determining that the first player character is located in a front orientation of the second player character, a first thermal value corresponding to the front orientation as the target thermal value for the second player character; or
taking, in response to determining that the second player character is located in a back orientation of the second player character, a second thermal value corresponding to the back orientation as the target thermal value for the second player character.

14. The method according to claim 10, wherein calculating the target thermal value for the second player character by using the relative distance, comprises:
taking a preset thermal distance range successfully matched with the relative distance as a target distance range; and taking a thermal value corresponding to the target distance range as the target thermal value for the second player character.

15. The method according to claim 1, wherein the thermal information comprises a thermal value; and adding the corresponding thermal state to the second player character according to the thermal information comprises at least one of:
adding, in response to determining that a current thermal value for the second player character is greater than or equal to a first thermal threshold and less than a second thermal threshold, a first-stage thermal state corresponding to the first thermal threshold to the second player character, wherein the first-stage thermal state is a state in which the second player character is configured to be identifiable and to be interacted by a non-player character;
adding, in response to determining that the current thermal value for the second player character is greater than or equal to the second thermal threshold and less than a third thermal threshold, a second-stage thermal state corresponding to the second thermal threshold to the second player character, wherein the second-stage thermal state is a state in which the second player character is configured to be interfered by a non-player character; or
adding, in response to determining that the current thermal value for the second player character is greater than or equal to the third thermal threshold, a third-stage thermal state corresponding to the third thermal threshold to the second player character, wherein the third-stage thermal state is a state in which the second player character stays in place.

16. The method according to claim 15, further comprising:
adding, in response to detecting that the third-stage thermal state of the second player character is ended, the second-stage thermal state to the second player character.

17. The method according to claim 1, further comprising:
displaying a character avatar of the second player character and a thermal strip in the graphical user interface.

18. The method according to claim 17, wherein the thermal information comprises a thermal value, and the method further comprises:
performing, in response to determining that a current thermal value for the second player character is not increased within a preset duration, decrement on a thermal value for the second player character at every preset time interval.

19. The method according to claim 1, wherein the content displayed in the graphical user interface further comprises a skill control corresponding to the game skill of the first player character; and displaying, in response to the trigger instruction for the game skill, the character capture area corresponding to the game skill in the graphical user interface, comprises at least one of:
displaying, in response to a touch operation for the skill control, the character capture area corresponding to the game skill and an image collection control corresponding to the character capture area in the graphical user interface; and controlling the first player character to perform an image collection action; or
hiding, in response to a touch operation for the skill control, the character capture area in the graphical user interface.

20. The method according to claim 19, wherein obtaining, in response to the image collection instruction and in response to determining that the second player character is located in the character capture area, the position relationship between the first player character and the second player character in the game scene, comprises:
performing, in response to a touch operation for the image collection control, image collection on a content in the character capture area to obtain a target image; and
obtaining, in response to determining that the target image comprises the second player character, the position relationship between the first player character and the second player character in the game scene.

21. (canceled)

22. (canceled)

23. (canceled)

24. (canceled)
